(19) United States
(12) Patent Application Publication
(10) Pub. No.: US 2006/0056762 A1
(43) Pub. Date: Mar. 16, 2006

(54) Lens optical coupler

(75) Inventors: Bo Su Chen, Plano, TX (US); Raymond W. Blasingame, Richardson, TX (US); James D. Orenstein, Duncanville, TX (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Honeywell International Inc.

(21) Appl. No.: 10/612,660

(22) Filed: Jul. 2, 2003

(51) Int. Cl. G02B 6/32

(52) U.S. Cl. 385/33; 385/35

(57) ABSTRACT

An optical coupling system having a high efficiency in coupling light from a light source to an optical fiber. The system may have a ball lens and an aspherical lens situated along the same optical path. The ball lens may be glass and the aspherical lens may be plastic. The ball lens may have optical aberrations common to spherical lenses. The aspherical lens may compensate for such aberrations. The glass ball lens may carry more power and have better thermal properties than the plastic lens, and thus compensate for latter's possibly weaker thermal properties. Together, the system may have sufficient power, low distortion, good thermal characteristics and high coupling efficiency.

### BACKGROUND

The invention pertains to optical couplers and particularly to couplers used for conveying laser light from a source into an optical fiber.

Several patent documents may be related to optical coupling between optoelectronic elements and optical media. They include U.S. Pat. No. 6,086,263 by Selli et al., issued Jul. 11, 2000, entitled “Active Device Receptacle” and owned by the assignee of the present application; U.S. Pat. No. 6,302,596 B1 by Cohen et al., issued Oct. 16, 2001, and entitled “Small Form Factor Optoelectronic Receivers”; U.S. Pat. No. 5,692,083 by Bennet, issued Nov. 25, 1997, and entitled “In-Line Unitary Optical Device Mount and Package therefore”; and U.S. Pat. 6,536,959 B2, by Kuhn et al., issued Mar. 25, 2003, and entitled “Coupling Configuration for Connecting an Optical Fiber to an Optoelectronic Component”; which are herein incorporated by reference.

Coupling efficiency between light sources and optical media is an important factor in various communications and other applications. Coupling efficiency, for instance, from a laser source to a single mode fiber not only is affected by a mismatch between the laser field/fiber-mode but also by aberrations in the coupling optics. A single ball lens may be used for single mode fiber coupling, but because of the spherical aberration from the ball lens, the coupling efficiency may be only about fifty percent. However, many communications applications need higher coupling efficiencies because of distance, weak light sources and high data rates. An aspherical glass lens is able to achieve high fiber coupling but its cost may be too high for practical use.

### SUMMARY

The present invention is a low cost, highly efficient system for coupling light from a light source into optical fiber. Among other features, it may have a spherical lens and an aspherical lens situated on the same optical path.

### BRIEF DESCRIPTION OF THE DRAWING

FIG. 1 is a diagram of an optical system with only a ball lens;

FIG. 2 shows an optical system with a convex aspherical design;

FIG. 3 shows an optical system with an alternative convex aspherical design;

FIG. 4 shows an optical coupling system with a concave aspherical design;

FIG. 5 is a graph of coupling efficiency versus deviation of the output relative to the optical fiber of the system of FIG. 4;

FIG. 6 is a graph of the coupling efficiency of the system versus it temperature; and

FIG. 7 is a graph of the ray aberrations of the system of FIG. 4.

### DESCRIPTION

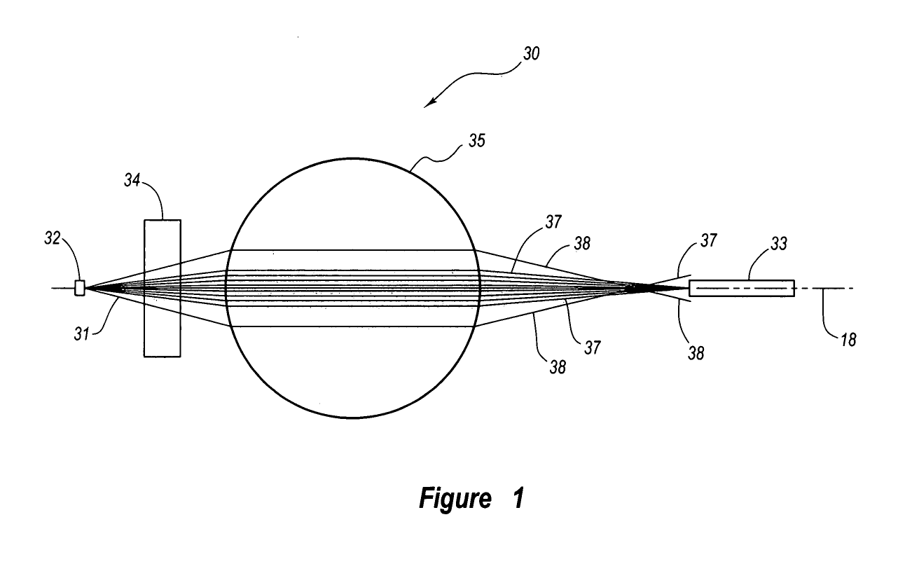

FIG. 1 shows a system 30 for coupling a light source 32 to an optical fiber 33. System 30 may have only one lens 35 which is a glass ball lens. Light 31 may propagate from source 32 through window 34 and lens 35. From lens 35 is spherically focused light 37 of which may match the fiber mode and couple into the end of fiber 33. The other spherically focused light 38 from lens 35 may mismatch the fiber mode and miss the end of fiber 33 and therefore will not be coupled into the fiber 33.

Source 32 of FIG. 1 may be about 381 microns (15 mils) from the closer surface of window 34. One may note that if a flip chip is used, window 34 may be spaced such that it is in intimate contact or nearly so with source 32. Window 34 may be about 203 microns (8 mils) thick. Window 34 may be about 264 microns (10.4 mils) from lens 35. Lens 35 may have a diameter of about 1.5 millimeters (59 mils). The distance from lens 35 may be about 1.212 millimeters (47.7 mils) from the end of fiber 33. The above-noted length measurements are along an optical axis 18.

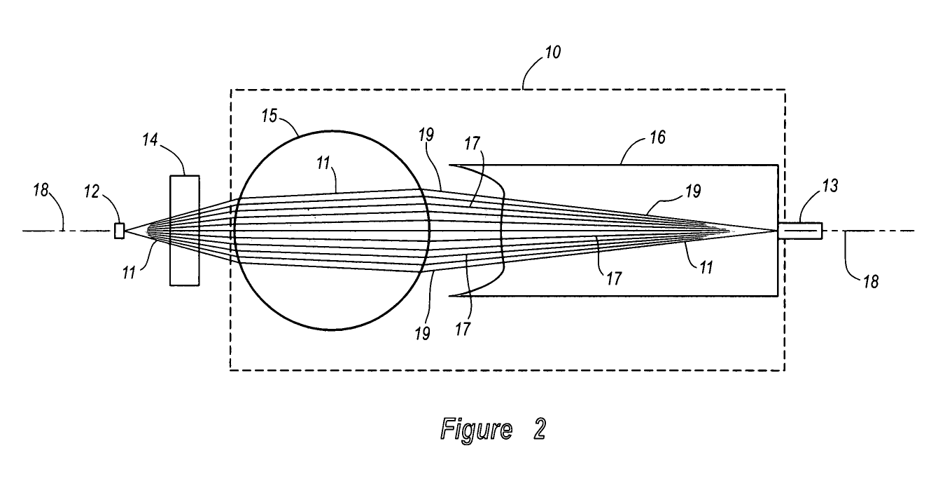

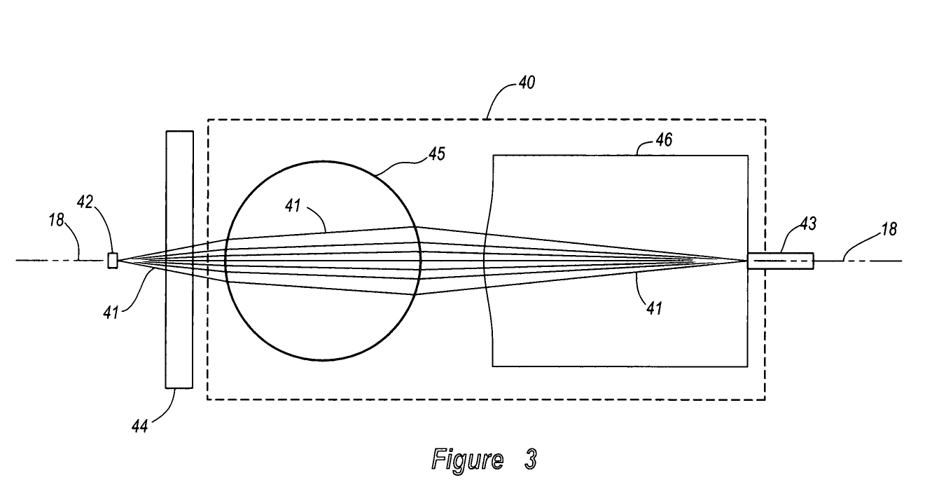

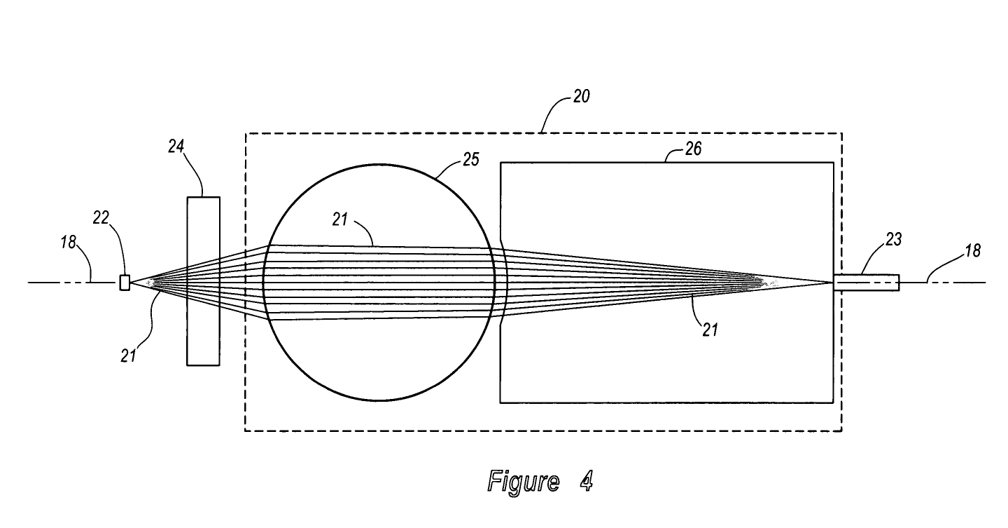

FIG. 2 reveals an illustrative example of the invention. Coupler system 10 may be a two-lens device used for coupling light 11 from a light source such as, for example, a vertical cavity surface emitting laser (VCSEL) 12, into a single mode (SM) optical fiber 13. Light 11 may propagate through a spherical ball lens 15. Light 17 may exit lens 15 and be focused on an end of a fiber 13 like that of light 37 of FIG. 1. However, because of the spherical aberration from the ball lens, light 19 might not be focused on the end of fiber 13 along with light 17 in the same manner as light 38 is not focused along with light 37 on the end of fiber 33 in FIG. 1. Light 17 and 19 in FIG. 2 may enter an aspherical lens 16. Lens 16 may be shaped in a non-spherical way to focus light 17 and 19 on to the end of fiber 13 at the same time. A similar arrangement and principle of focusing may appear in coupling systems 20 and 40 of FIGS. 4 and 3, respectively.

VCSEL 12 may be a single mode source. Light 11 may propagate through a protective window 14 of a (hermetically) sealed package containing the VCSEL onto a ball lens 15. The distance between VCSEL 12 and the surface of window 14 closer to VCSEL 12 may be about 380 microns (15 mils). Window 14 may be about 203 microns (8 mils) thick and consist of BK7™, Corning #7052, or any suitable transmissive material. The distance between the surface of the window 14 (closer to lens 15) and lens 15 may be about 280 microns (11 mils) along the optical axis. Spherical lens 15 may be about 1.5 millimeters (59 mils) in diameter. Lens 25 may be a glass ball lens. It may be composed of BK7™, LaSFN9, or any suitable material. Light 11 may move through lens 15 and out of it into an aspherical lens 16. The distance between lens 15 and lens 16 may be about 561 microns (22.1 mils). Light 11 may propagate through lens 16 into optical fiber 13. The end of fiber 13 may be in physical contact with lens 16 but not required to be so. The length of lens 16 may be about 209 microns (82.3 mils). The above-noted length measurements are along the optical axis. Lens 16 may be a convex lens made from Zeonex™ E48R available from Zeon Chemicals L.P., 4111 Bells Lane, Louisville, Ky. 40211. The lens may also be made from GE ULTEM. A 1.5 mm ball lens 15 of BK7™ material may be available from Edmund Industrial Optics, 101 East Gloucester Pike, Barrington, N.J. 08007-1380. Optical fiber 13 may be an SMF-28™ single mode optical fiber available from Corning Incorporated, One Riverfront Plaza, Corning, N.Y. 14831. One may note that the dimensions illustrated above are typical and other geometries may be functional as well.

The present optical coupler may have both high coupling efficiency and low cost. The coupling optics may use a glass ball lens and a molded aspherical lens. The aberration of the ball lens may degrade the efficiency of the coupling system. However, the ball lens' spherical aberration may be compensated by the light ray directing properties of the aspherical plastic lens. Since the ball lens may have significantly more optical power than the plastic lens in the coupling system, the plastic lens' poor thermal properties may be compensated for and minimized. Therefore, an appropriately designed combination of a glass ball lens and plastic molded aspherical lens may provide a thermally stable and highly efficient optical coupling system.

Lens 16 may be composed of glass or be a single aspherical glass lens. Glass aspherical lenses may have good thermal properties and less aberration than a ball lens. They may be somewhat expensive and difficult to produce. Plastic aspherical lenses may be easily and inexpensively producible; however, they do not have thermal properties as good as the glass lenses. Yet the plastic aspherical lenses have much less aberration than the ball lenses. For instance, light rays coming from a spherical lens periphery may form an image before the ideal focal point. For this reason, the spherical aberration (a blurred image) may occur at the center portion of the image formed. Or if the focus is readjusted for the center portion of the image, then the spherical aberration (again, a blurred image) may occur at the periphery of the image. In other words, it may not be possible for all of the parallel rays going through a spherical lens to converge at one point. An awkward and cumbersome multitude of spherical lenses might be designed to partially correct this aberration problem. However, one aspherical lens may be designed to gather or converge all of the parallel rays of light to one focal point. The aspherical lens may have surface with a specially designed curvature to achieve this convergence of the light rays. The aspherical lens surface does not completely conform to the shape of a sphere like that of a spherical lens. Mass production technologies including plastic mold technology may be used to mold aspherical lenses by pouring or injecting plastic material into a rather precise aspherical mold. Further, the aspherical lens may achieve a coupling efficiency into a single mode fiber above ninety percent for coupling systems 10, 20 and 40. This is a desired performance feature for VCSEL communication applications since VCSEL optical power is relatively low compared to other laser sources. Significant power is better conveyed with a glass aspherical lens; however, the cost of a glass aspherical lens is high (i.e., greater than eight dollars per lens in year 2000 with high volume pricing). The inexpensive (i.e., less than a dollar with high volume pricing) aspherical lens may be the poured or injection molded plastic lens. The aspherical lens may be made of another material similar to plastic. The plastic lens may have poor thermal characteristics but a glass ball lens may compensate for those characteristics in a coupling system with the plastic lens. The ball lens may be made of another material similar to glass.

A design for the aspherical convex lens 16 may be indicated by the following equation and parameter values.
z={cr²/[1+(1−(1+k)c²r²)^{1/2}]}+A₆r⁶+A₈r⁸

Surface 1
c=1/R; R=1.457374 (Unit: mm)
k=−18.455693
A₆=−24.768767
A₈=−20.028863

Illustrative examples of the invention have an optical design which may possess both high coupling efficiency and low cost. The spherical aberration of ball lens 15 may be compensated for by aspherical plastic lens 16. Because ball lens 15 may convey the most optical power in system 10, the combination of a glass ball lens and plastic molded optics may provide thermal stability and high coupling efficiency for optoelectronic element and single mode optical fiber coupling applications.

FIG. 3 is a layout of an optical coupler system 40 having a convex aspherical lens 46 that may have a different design than that of convex aspherical lens 16 of system 10. Similarly, light source 42 may emit a light 41 that goes through a hermetically sealed window of the package wherein light source 42 is situated. Light 41 may go through a ball lens 45 and convex aspherical lens 46. The light from lens 46 may enter fiber 43. Components 42, 45, 46 and 43 may be situated on an optical axis 18. Aspherical lens 46 may be a plastic lens. The materials of the components and the dimensions may be similar those of system 10.

FIG. 4 reveals another illustrative example of the invention. Coupler system 20 may be a two-lens device for coupling light from a single mode (SM) VCSEL 22 into an SM optical fiber 23. The wavelength of the laser light from VCSEL 22 may be 1310 nm. Light 21 may propagate through a protective window 24 into a ball lens 25. VCSEL 22 may be about 381 microns (15 mils) from the closer surface of window 24. Window 24 may be about 203 microns (8 mils) thick. The surface of window 24 closer to lens 25 may be about 305 microns (12 mils) from lens 25. Lens 25 may have a diameter of about 1.5 millimeters (59 mils). It may be a glass ball lens. Light 21 may propagate through lens 25 and out of it into an aspherical lens 26. The distance between lens 25 and lens 26 may be about 76 microns (3 mils). Light 21 may propagate through lens 26 into optical fiber 23. Optical fiber 23 has an end that may be in contact with lens 26. The length of lens 26 may be about 205.7 microns (81 mils). The above-noted length measurements may be along the optical axis. The dimensions may be illustrative examples and may be of other appropriate magnitudes. Lens 26 may be a concave Zeonex™ E48R (or any other suitable plastic material) lens. However, lens 26 could be composed of glass, but because of the high cost (as noted above) of glass aspherical lenses, lens 26 may be a poured or an injected molded plastic lens.

Lens 25 may be a 1.5 mm ball lens made of LaSFN9™ material available from Edmund Industrial Optics. Lens 26 may be made of Zeonex™ E48R material available from Zeon Chemicals L.P. Fiber 23 may be an SMF-28™ single mode optical fiber available from Corning Incorporated. Window 24 may be made from BK7™ material available from various vendors. Window 24 may be a hermetically sealed window of a TO-56 can or other package incorporating light source 22 such as a VCSEL.

Like system 10, coupler system 20 may have thermal stability and high coupling efficiency for coupling light into SM (single mode) optical fiber 23. In the above-described systems 10, 20 and 40, end faces of optical fibers 13, 23 and 43, respectively, may be situated so as to be in contact with aspherical lenses 16, 26 and 46, as shown in the respective FIGS. 2-4, or the end faces of fibers 13, 23 and 43 may be situated at distance from lenses 16, 26 and 46, respectively (not shown). Also, the order of ball lenses 15, 25 and 45 and of aspherical lenses 16, 26 and 46 along optical axis 18 may be different than that as shown. The systems disclosed here may be operated with a light source having a wavelength of about 1310 nm but may be at another wavelength, such as 850 nm or 1550 nm as well as other wavelengths. The light source may be replaced with a detector and the source of light may be from the optical medium or fiber.

In systems 10, 20 and 40, light sources 12, 22 and 42 may be single mode VCSELs or other sources of that mode. However, they may be multimode VCSELs or other sources of that mode. The optical fibers 13, 23 and 43 of these systems may be single mode or multimode, as applicable.

A design for aspherical concave lens 26 may be indicated by the following equation and parameter values.
z={cr²/[1+(1−(1+k)c²r²)^{1/2}]}+A₂r²+A₄r⁴

Surface 1
c=1/R; R=−1.576039 (Unit: mm)
k=33.774232
A₂=0.018687
A₄=−2.347015

The following chart shows the coupling efficiency of system 20 versus deviation of the alignment of the output of the system with optical fiber 23. This chart appears to reveal system 20 as having a good tolerance to some misalignment of its output with optical fiber 23 to which system 20 is coupling light from light source 22.

Coupling Efficiency

| YDE: | | .00000 | .00100 | .00200 | .00300 | .00400 | .00500 |
|---|---|---|---|---|---|---|---|
| XDE | | | | | | | |
| .00000 | \| | .96565 | .90779 | .77890 | .61595 | .41840 | .26323 |
| .00100 | \| | .90779 | .85319 | .73169 | .57822 | .39225 | .24636 |
| .00200 | \| | .77890 | .73169 | .62675 | .49452 | .33446 | .20926 |
| .00300 | \| | .61595 | .57822 | .49452 | .38938 | .26231 | .16329 |
| 00400 | \| | .41840 | .39225 | .33446 | .26231 | .17535 | .10808 |
| .00500 | \| | .26323 | .24636 | .20926 | .16329 | .10808 | .06577 |

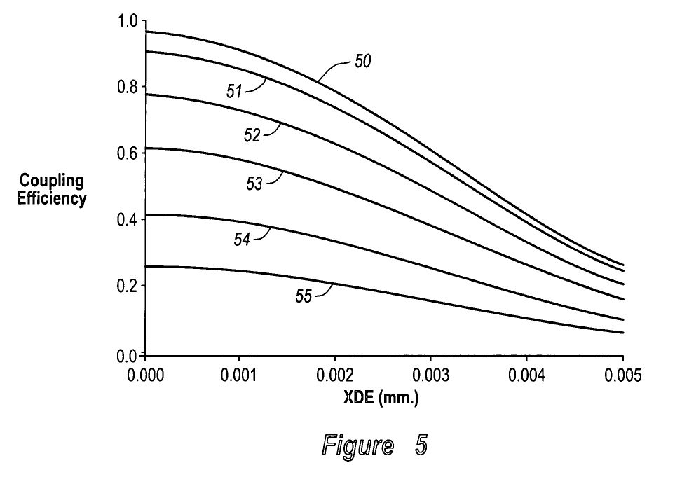

FIG. 5 is a graph that charts coupling efficiency of the present coupling system 20 versus deviation of the alignment of the output of the system with the optical fiber 23 with the use of ray-based tracing. The y-axis or ordinate axis indicates the coupling efficiency from 0 to 1.0 or 100 percent. An x-axis or abscissa axis indicates the horizontal or x-direction deviation of the core center of fiber 23 from 0 to 5 microns relative to optical axis 18. Each graph line represents a vertical or y-direction deviation of the core center of fiber 23 from optical axis 18. Lines 50, 51, 52, 53, 54 and 55 represent a y-direction or vertical deviation of 0, 1, 2, 3, 4 and 5 microns, respectively, of the core center of fiber 23 relative to optical axis 18.

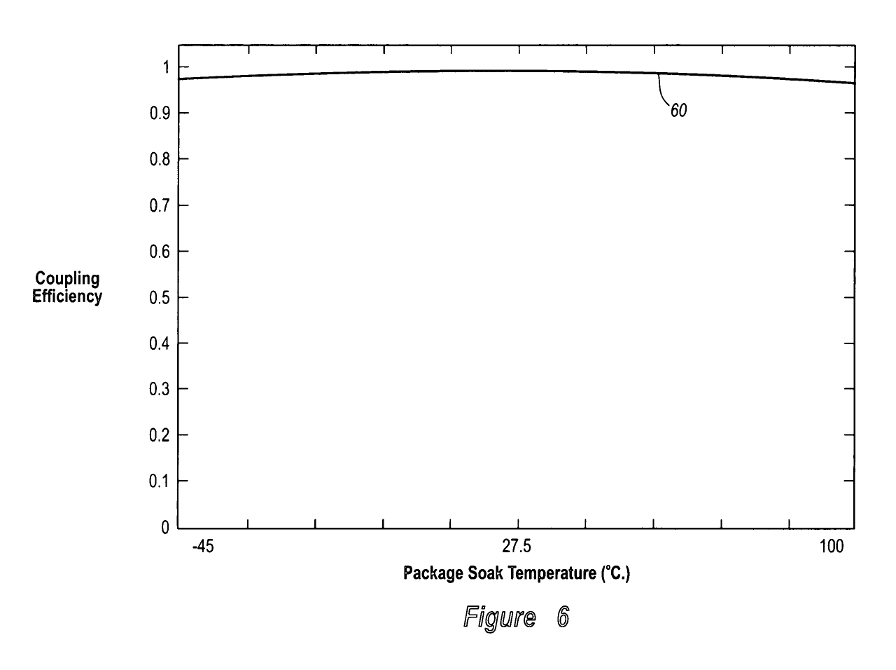

FIG. 6 is a graph of the coupling efficiency of system 20 versus it package soak temperature from −45 to 100 degrees Centigrade (−49 to 212 degrees F.) as shown by line 60. This graph may demonstrate the thermal stability of system 20. System 10 may be regarded to have similar coupling efficiencies under conditions like those of system 20.

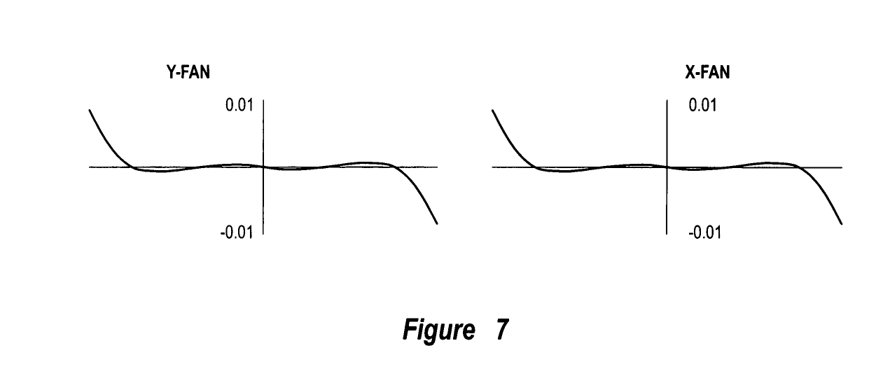

FIG. 7 graphs the aberrations of the across the output face of system 20 in an x-axis direction and a y-axis direction. This graph appears to reveal system 20 to have a rather distortion free output.

Coupler systems 10, 20, 30 and 40 may be a part of an array of light sources such as VCSELs and an array of fibers to which that the light is coupled. On the other hand, components 12, 22, 32 and 42 may be detectors receiving light from their respective coupling systems that are receiving light from an optical fiber or fibers. The coupled light may include light signals such as communications signals.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. An optical coupler comprising:
a spherical lens; and
an aspherical lens; and
wherein said lenses are situated in the same optical path.

2. The coupler of claim 1, wherein:
said spherical lens comprises a glass material; and
said aspherical lens comprises a non-glass material.

3. The coupler of claim 2, wherein said spherical lens is a ball lens.

4. The coupler of claim 3, wherein said aspherical lens comprises a plastic material.

5. The coupler of claim 4, wherein said aspherical lens is approximately concave.

6. The coupler of claim 4, wherein said aspherical lens is approximately convex.

7. The coupler of claim 5, wherein said aspherical lens is a molded plastic lens.

8. The coupler of claim 6, wherein said aspherical lens is a molded plastic lens.

9. The coupler of claim 7, wherein said aspherical lens is injection molded.

10. The coupler of claim 8, wherein said aspherical lens is injection molded.

11. The coupler of claim 3, wherein:
a light source is situated proximate to said spherical lens; and
an optical medium is situated proximate to said aspherical lens;

12. The coupler of claim 11, wherein light from the light source may propagate through said spherical lens and said aspherical lens, respectively.

13. The coupler of claim 12, further comprising a window situated between the light source and said spherical lens.

14. The coupler of claim 13, wherein the optical medium is an optical fiber.

15. The coupler of claim 14, wherein the light source is a vertical cavity surface emitting laser.

16. The coupler of claim 15, wherein the optical fiber is single mode.

17. An optical coupling system comprising:
a spherical ball lens; and
an aspherical lens; and
wherein said spherical ball lens and said aspherical lens are situated on-a common optical axis.

18. The system of claim 17, wherein said aspherical lens is coupled to an optical fiber.

19. The system of claim 18, wherein said aspherical lens is composed of a non-glass material.

20. The system of claim 19, wherein said aspherical lens is composed of a plastic material.

21. A coupling means comprising:
means for spherically focusing light from a light source;
means for aspherically focusing light from said means for spherically focusing light; and
means for inputting light into an optical medium from said means for aspherically focusing light.

22. The coupling means of claim 21, wherein:
the light source is a laser; and
the optical medium is a fiber.

23. The coupling means of claim 22, wherein:
the laser is a vertical cavity surface emitting laser; and
the fiber is a single mode optical fiber.

24. The coupling means of claim 23, wherein said means for spherically focusing light conveys more light power than said means for aspherically focusing light.

25. The coupling means of claim 24, wherein:
said means for spherically focusing light uses glass-like material for focusing light; and
said means for aspherically focusing light uses plastic-like material for focusing light.

26. A method for coupling light, comprising:
spherically focusing light from a light source resulting in a first portion of light having a first focal point on an optical axis and a second portion of light having a second focal point on the optical axis; and
aspherically focusing the first portion of light and the second portion of light resulting in the first and second portions of light having a common focal point.

27. The method of claim 26, wherein:
spherically focusing the light from the light source is effected by a ball lens; and
aspherically focusing the first and second portions of light from the ball lens is effected by an aspherically-shaped lens.

28. The method of claim 27, wherein the common focal point is at a place of an optical medium.

29. The method of claim 28, wherein:
the ball lens comprises a glass-like material; and
the aspherically-shaped lens comprises a plastic-like material.

30. The method of claim 29, wherein:
the light source is a laser; and
the optical medium is an optical fiber.

31. The method of claim 30, wherein:
the laser is a vertical cavity surface emitting light source; and
the optical fiber is a single mode fiber.

32. An optical coupler comprising:
an aspherical lens on an optical axis; and
a spherical lens on an optical axis; and
wherein:
said aspherical lens is proximate to an optoelectronic element; and
said spherical lens is proximate to an optical medium.

33. The coupler of claim 32, wherein:
said aspherical lens comprises a plastic-like material; and
said spherical lens comprises a glass-like material.

34. The coupler of claim 33, wherein said spherical lens is a ball lens.

35. The coupler of claim 34, wherein:
said optoelectronic element is a light source; and
said optical medium is an optical fiber.

36. The coupler of claim 35, wherein the light source is a laser.

37. The coupler of claim 36, wherein:
the laser is a vertical cavity surface emitting laser; and
the optical fiber is single mode fiber.

38. The coupler of claim 34, wherein:
the optoelectronic element is a detector; and
said optical medium is an optical fiber.

39. The coupler of claim 38, wherein said optical fiber is single mode fiber.

40. The coupler of claim 38, wherein said optical fiber is multimode fiber.
